(19) United States
(12) Patent Application Publication
(10) Pub. No.: US 2014/0100494 A1
(43) Pub. Date: Apr. 10, 2014

(54) SMART GAIT REHABILITATION SYSTEM FOR AUTOMATED DIAGNOSIS AND THERAPY OF NEUROLOGIC IMPAIRMENT

(71) Applicants: Thompson Sarkodie-Gyan, El Paso, TX (US); Adrian Trejo, El Paso, TX (US)

(72) Inventors: Thompson Sarkodie-Gyan, El Paso, TX (US); Adrian Trejo, El Paso, TX (US)

(73) Assignee: BOARD OF REGENTS, THE UNIVERSITY OF TEXAS SYSTEM, Austin, TX (US)

(21) Appl. No.: 14/107,954

(22) Filed: Dec. 16, 2013

Related U.S. Application Data
(63) Continuation-in-part of application No. 12/790,061, filed on May 28, 2010.
(60) Provisional application No. 61/183,723, filed on Jun. 3, 2009.

(51) Int. Cl. A61H 3/00

(52) U.S. Cl. CPC A61H 3/00
USPC 601/35

(57) ABSTRACT

The present invention describes a Smart Gait Rehabilitation System (SGRS). The present invention is capable of performing a quantitative analysis of human movements based on the simultaneous measurement of within-subject stride-to-stride changes in gait using accelerometers, gyroscopes, goniometers, and electromyography (EMG). The system described in the present invention is based on step-training that incorporates sensory feedback, provide feedback about kinematics and torques, and proceeds at walking speeds typical of overground ambulation.

### CROSS-REFERENCE TO RELATED APPLICATIONS

This application is a continuation-in-part of co-pending U.S. patent application Ser. No. 12/790,061 filed May 28, 2010, which is a non-provisional application of U.S. Provisional Application Ser. No. 61/183,723 filed Jun. 3, 2009, the entire contents of which are incorporated herein by reference.

### TECHNICAL FIELD OF THE INVENTION

The present invention relates in general to the field of diagnostic and therapeutic techniques, and more particularly, to the development of a device that improves recovery processes after neurologic impairment and strongly emphasizes functional training as the key to optimal functional recovery of gait after impairment.

### STATEMENT OF FEDERALLY FUNDED RESEARCH

None.

### BACKGROUND OF THE INVENTION

Without limiting the scope of the invention, its background is described in connection with the devices for neurologic impairments.

U.S. Pat. No. 7,381,192 issued to Brodard et al. (2008) describes a device for re-educating and/or training the lower limbs of a person, in particular a person having an impairment of the central nervous system (paraplegia, hemiplegia). The device comprises a mechanical orthotic device arranged to constitute an interface with at least one of the lower limbs of the patient and a neuromuscular stimulation device comprising at least one pair of electrodes intended to act on the relevant muscle or muscle group of the limb of the patient. The orthotic device comprises at least one articulation provided with an actuating motor of the orthesis and with an angular sensor and at least one force sensor, the sensors being coupled to a control device controlling the stimulation device, with closed-loop continuously controlled in real time retrocontrol means of stimulation device, thereby generating a neuromuscular stimulation providing an active motion of limbs of the patient, in a manner which is coordinated with a closed-loop continuous control system controlling the actuating motor of the orthesis in real time.

U.S. Pat. No. 7,179,234 (Nashner, 2007) describes a method and apparatus for characterizing contributions of forces associated with a body part of a subject when the body part is involved in movement is provided. The method includes causing movement of the body part in a prescribed manner and monitoring quantities related to at least one of displacement of the body part and external force on the body part. At least one quantity related to a force contribution associated with the body part is determined from the quantities measured.

United States Patent Application No. 20040172097 (Brodard et al., 2004) describes a device for re-educating and/or training the lower limbs of a person, in particular a person having an impairment of the central nervous system (paraplegia, hemiplegia).

United States Patent Application No. 20050043661 (Nashner, 2005) describes a method for characterizing contributions of forces associated with a body part of a subject when the body part is involved in movement, the method comprising: causing movement of the body part in a prescribed manner; monitoring quantities related to at least one of displacement of the body part and external force on the body part; and determining at least one quantity related to a force contribution associated with the body part from the quantities measured.

United States Patent Application No. 20070135265 (Nashner, 2007) discloses a method and apparatus for characterizing contributions of forces associated with a body part of a subject when the body part is involved in movement is provided. The method includes causing movement of the body part in a prescribed manner and monitoring quantities related to at least one of displacement of the body part and external force on the body part. At least one quantity related to a force contribution associated with the body part is determined from the quantities measured.

United States Patent Application No. 20050239613 (Colombo et al., 2005) describes a device for adjusting the height of and relief force acting on a weight is especially provided to be used for walking therapy of paraparetic or hemiparetic patients within a locomotion training means. The weight of the patient is supported by a cable. A first cable length adjustment means provides an adjustment of the length of the cable to define the height of the suspended weight. A second cable length adjustment means provides an adjustment of the length of the cable to define the relief force acting on the suspended weight. This allows a quick and reliable determination and adjustment of the height for different patients and of the relief force within the training program of every patient.

United States Patent Application No. 20050288157 (Santos-Munne et al., 2005) discloses a pelvic support unit coupled to a base by a powered vertical force actuator mechanism. A torso support unit, which is affixed to the patient independently of the pelvic support unit, is connected to the base by one or more powered articulations which are actuable around respective axes of motion. Sensors sense the linear and angular displacement of the pelvic support unit and the torso support unit. A control unit is coupled to these sensors and, responsive to signals from them, selectively control the displacement actuator and articulation(s). Wheel modules are independently powered to both rotate and steer, and, responsive to the control unit, are capable of rolling the exercise device in a direction of travel intended by the patient.

### SUMMARY OF THE INVENTION

The present invention describes develop an automated diagnostic and therapeutic technique to improve recovery processes after neurologic impairment and to strongly emphasize functional training as the key to optimal functional recovery of gait after impairment.

In one embodiment, the present invention includes a lower limb movement structure (10) for re-educating and/or training one or more lower limbs of a subject having an impairment of the central nervous system, comprising: at least two powered lower limb structures; and one or more support structures or plates; wherein the two powered lower limb structures are secured to the one or more support structures or plated using bolts attached to a linear actuator. In one aspect, the powered lower limb structures comprise: a height adjuster assembly (12); a hip movement assembly (14); wherein the height adjuster assembly (12) is attached to the hip movement assembly (14) through a bearing connected to the one or more support structures or plates (20); a thigh movement assembly (16); wherein the hip movement assembly (14) is attached to the thigh movement assembly (16) by a bolt protruding through the upper end of the linear actuator and through the hip movement assembly; and a calf movement assembly (18); wherein the thigh movement assembly (16) is attached to the calf movement assembly (18) through the bearing (24) connected by support structures or plates (20). In another aspect, the one or more holes in the support structures or plates and hip movement assembly are fitted with bearings (24) to allow rotation between hip movement assembly and thigh movement assembly.

In one aspect, the central nervous system impairment comprises a hemiplegic stroke, a paraparesis from spinal cord injuries, an upper motor neuron syndrome, a serious mobility-related disability or any combinations thereof. In another aspect, the device further comprises a knowledge-based control system that is coupled to the lower limb movement structure, wherein the knowledge-based control system comprises a sensing and a data acquisition module, wherein the knowledge-based control system controls at least one of the height adjuster assembly (12); the hip movement assembly (14); the thigh movement assembly (16); and the calf movement assembly (18) of the lower limb movement structure 10. In another aspect, the knowledge-based control system further comprises: one or more measurement systems for measuring stride-to-stride changes in gait; and a quantitative system for movement analysis based on stride-to-stride changes in gait. In another aspect, the one or more measurement systems are selected from a group comprising accelerometers, gyroscopes, goniometers, and electromyography (EMG). In another aspect, the sensing and data acquisition module of the knowledge-based control system further comprises: a database module (40), a decision/inference module (42), a knowledge base module (36), one or more modules (38) for identification of a problem and for connecting to the human patient (30) and to a lower limb movement structure control system (50); and a—biological information monitor module (46) that provides feedback to a patient.

In another embodiment, the present invention includes a system for predicting the outcome of a physical therapy regimen or recovery in a patient following an impairment of the central nervous system, comprising: a mechanical lower limb movement structure (10) attachable to the patient; wherein the lower limb movement structure (10) comprises two or more powered lower limb structures connected via one or more support structures or plates, a knowledge-based control system that comprises a sensing and data acquisition module connected to one or more sensors; one or more sensors that measure within-subject stride-to-stride changes of the patient analyzers that analyze the movements quantitatively based on the measurements of the within-subject stride-to-stride changes; and a unit that predicts the outcome of a physical therapy regimen or recovery in the patient based on the quantitative results of the measurements of the within-subject stride-to-stride changes.

In one aspect, the central nervous system impairment comprises hemiplegic stroke, paraparesis from spinal cord injuries, and other upper motor neuron syndromes, serious mobility-related disabilities or any combinations thereof. In another aspect, the one or more measurement systems are selected from a group comprising accelerometers, gyroscopes, goniometers, and electromyography (EMG). In another aspect, the powered lower limb structures comprise: a height adjuster assembly (12); a hip movement assembly (14); wherein the height adjuster assembly (12) is attached to the hip movement assembly (14) through a bearing connected to the one or more support structures or plates (20); a thigh movement assembly (16); wherein the hip movement assembly (14) is attached to the thigh movement assembly (16) by a bolt protruding through the upper end of the linear actuator and through the hip movement assembly; and a calf movement assembly (18); wherein the thigh movement assembly (16) is attached to the calf movement assembly (18) through the bearing (24) connected by support structures or plates (20). In another aspect, the one or more holes in the support structures or plates and hip movement assembly are fitted with bearings (24) to allow rotation between hip movement assembly and thigh movement assembly.

In one embodiment, the present invention includes a method for designing a passive gait or locomotor training regimen, or diagnosing gait comprising the steps of: attaching a mechanical lower limb movement structure (10) to a subject; wherein the lower limb movement structure (10) comprises two powered lower limb structures, one or more support structures or plates, a knowledge-based control system that comprises a sensing and data acquisition module; measuring within-subject stride-to-stride changes using one or more measurement systems; analyzing the movements quantitatively based on the measurements of the within-subject stride-to-stride changes; and diagnosing gait or designing a gait or locomotor training regimen based on the quantitative results of the measurements of the within-subject stride-to-stride changes. In another aspect, the one or more measurement systems are selected from a group comprising accelerometers, gyroscopes, goniometers, and electromyography (EMG). In another aspect, the central nervous system impairment comprises hemiplegic stroke, paraparesis from spinal cord injuries, and other upper motor neuron syndromes, serious mobility-related disabilities or any combinations thereof. In another aspect, the one or more measurement systems are selected from a group comprising accelerometers, gyroscopes, goniometers, and electromyography (EMG). In another aspect, the powered lower limb structures comprise: a height adjuster assembly (12); a hip movement assembly (14); wherein the height adjuster assembly (12) is attached to the hip movement assembly (14) through a bearing connected to the one or more support structures or plates (20); a thigh movement assembly (16); wherein the hip movement assembly (14) is attached to the thigh movement assembly (16) by a bolt protruding through the upper end of the linear actuator and through the hip movement assembly; and a calf movement assembly (18); wherein the thigh movement assembly (16) is attached to the calf movement assembly (18) through the bearing (24) connected by support structures or plates (20).

In another aspect, the one or more holes in the support structures or plates and hip movement assembly are fitted with bearings (24) to allow rotation between hip movement assembly and thigh movement assembly. In another aspect, the knowledge-based control system further comprises: one or more measurement systems for measuring stride-to-stride changes in gait; and a quantitative system for movement analysis based on stride-to-stride changes in gait. The one or more measurement systems can be selected from a group comprising accelerometers, gyroscopes, goniometers, and electromyography (EMG). In another aspect, the sensing and data acquisition module of the knowledge-based control system further comprises: a database module (40), a decision/inference module (42), a knowledge base module (36), one or more modules for identification of a problem (38) and for connecting to the sensors 32 that are connected to the human patient (30) and to a low limb movement structure control system (50); and a biological information monitor module (46) that provides feedback to a patient 30. In another aspect, the device is further defined as comprising one or more sensors are attached to each of the height adjuster assembly (12); the hip movement assembly (14); the thigh movement assembly (16); the calf movement assembly (18) or combinations thereof. In another aspect, the knowledge-based control system receives input from the one or more sensors that comprises: a localization module that establishes which sensor has failed; an identification module that determines the type of failure; and an estimation module that calculates the effect and extent of the failure. In another aspect, the knowledge-based control system receives input from the one or more sensors and data from each of the sensors is integrated by a fuzzy rule-based algorithm. In another aspect, the knowledge-based control system integrates input from the one or more sensors; organizes the distributed sensing systems; integrates the sensors' diverse observations (inputs and outputs); coordinates and guides the decisions made by each sensor; and controls devices with the goal of improving sensor system performance. In another aspect, the method allows for training a subject in a passive, an active mode, or both depending on the therapeutic needs of the subject.

In one embodiment, the present invention includes a mechanical lower limb movement structure (10) for training one or more lower limbs of a subject having an impairment of the central nervous system, the mechanical lower limb movement structure comprising: at least two powered lower limb structures; one or more support structures or plates; wherein the at least two powered lower limb structures are secured to the one or more support structures or plates using bolts attached to a linear actuator; and a knowledge-based control system that comprises a sensing and data acquisition module that simultaneously receives data from a plurality of sensors that are associated with the subject and that integrates data that is simultaneously received from the plurality of sensors using a fuzzy rule-based algorithm and that uses the integrated data to identify a gait motion of the subject. In one aspect, the two or more powered lower limb structures comprise: a height adjuster assembly (12); a hip movement assembly (14); wherein the height adjuster assembly (12) is attached to the hip movement assembly (14) through a first bearing connected to the one or more support structures or plates (20); a thigh movement assembly (16); wherein the hip movement assembly (14) is attached to the thigh movement assembly (16) by a bolt protruding through the upper end of the linear actuator wherein the bolt also protrudes through the hip movement assembly; and a calf movement assembly (18); wherein the thigh movement assembly (16) is attached to the calf movement assembly (18) through a second bearing connected to the one or more support structures or plates (20). In another embodiment, the one or more holes in the support structures or plates and the hip movement assembly are fitted with the first bearing and the second bearing to allow rotation between the hip movement assembly and the thigh movement assembly. Ii one aspect, a human subject suspected of having a central nervous system impairment is selected from at least one of a hemiplegic stroke, a paraparesis from spinal cord injuries, an upper motor neuron syndrome, a serious mobility-related disability or any combinations thereof.

In another embodiment, the knowledge-based control system controls at least one of the height adjuster assembly (12); the hip movement assembly (14); the thigh movement assembly (16); and the calf movement assembly (18). In another embodiment, the knowledge-based control system further comprises: one or more measurement systems for measuring stride-to-stride changes in gait of a human subject; and a quantitative system for movement analysis based on stride-to-stride changes in gait of the human subject. In another aspect, the one or more measurement systems are selected from a group comprising accelerometers, gyroscopes, goniometers, electromyography (EMG) units, and instrumented treadmills. In another aspect, the knowledge-based control system further comprises: a database module (40), a decision/inference module (42), a knowledge base module (36), one or more modules (38) for identification of a problem and for receiving data from one or more sensors wherein the knowledge-based control system is connected to a lower limb movement structure control system (50); and to a biological information feedback monitor module (46) that provides feedback to a patient.

Another embodiment of the present invention includes a system for predicting the outcome of a physical therapy regimen or recovery in a patient following an impairment of the central nervous system, comprising the steps of: a mechanical lower limb movement structure attachable to the patient; wherein the lower limb movement structure comprises two or more powered lower limb structures connected via one or more support structures or plates, and a knowledge-based control system that comprises a sensing and data acquisition module connected to one or more sensors that are associated with the patient and that integrates data that is simultaneously received from the plurality of sensors using a fuzzy rule-based algorithm; one or more sensors that measure within-subject stride-to-stride changes of the patient; analyzers that analyze movements quantitatively based on the measurements of the within-subject stride-to-stride changes; and a unit that predicts the outcome of a physical therapy regimen or recovery in the patient based on the quantitative results of the measurements of the within-subject stride-to-stride changes. In one aspect, the central nervous system impairment comprises hemiplegic stroke, paraparesis from spinal cord injuries, and other upper motor neuron syndromes, serious mobility-related disabilities or any combinations thereof. In another aspect, the one or more sensors that measure within-subject stride-to-stride changes of the patient is selected from a group comprising accelerometers, gyroscopes, goniometers, and electromyography (EMG) units, and instrumented treadmills.

In another embodiment, the present invention includes a mechanical lower limb movement structure for training one or more lower limbs of a subject having an impairment of the central nervous system, the mechanical lower limb movement structure comprising: at least two powered lower limb structures; and one or more support structures or plates; wherein the at least two powered lower limb structures are secured to the one or more support structures or plates using bolts attached to a linear actuator; wherein the two or more powered lower limb structures comprise: a height adjuster assembly (12); a hip movement assembly (14); wherein the height adjuster assembly (12) is attached to the hip movement assembly (14) through a first bearing connected to the one or more support structures or plates (20); a thigh movement assembly (16); wherein the hip movement assembly (14) is attached to the thigh movement assembly (16) by a bolt protruding through the upper end of the linear actuator wherein the bolt also protrudes through the hip movement assembly; a calf movement assembly (18); wherein the thigh movement assembly (16) is attached to the calf movement assembly (18) through a second bearing connected to the one or more support structures or plates (20); and a knowledge-based control system that comprises a sensing and data acquisition module that simultaneously receives data from a plurality of sensors that are associated with the subject and that integrates data that is simultaneously received from the plurality of sensors using a fuzzy rule-based algorithm and that uses the integrated data to identify a gait motion of the subject.

In another aspect, the one or more holes in the support structures or plates and the hip movement assembly are fitted with the first bearing and the second bearing to allow rotation between the hip movement assembly and the thigh movement assembly.

In yet another embodiment, the present invention includes a method for making a passive gait or locomotor training regimen, or diagnosing gait for a subject, the method comprising the steps of: attaching a lower limb movement structure (10) to the subject; wherein the multi-axis robotic device comprises two powered lower limb structures, one or more support structures or plates, a knowledge-based control system, a knowledge-based sensing and a data acquisition and control system; measuring within-subject stride-to-stride changes using one or more measurement systems; analyzing the movements quantitatively based on the measurements of the within-subject stride-to-stride changes; and diagnosing gait or designing a gait or locomotor training regimen based on the quantitative results of the measurements of the within-subject stride-to-stride changes. In one aspect, the two or more powered lower limb structures comprise: a height adjuster assembly (12); a hip movement assembly (14); wherein the height adjuster assembly (12) is attached to the hip movement assembly (14) through a first bearing connected to the one or more support structures or plates (20); a thigh movement assembly (16); wherein the hip movement assembly (14) is attached to the thigh movement assembly (16) by a bolt protruding through the upper end of the linear actuator wherein the bolt also protrudes through the hip movement assembly; and a calf movement assembly (18); wherein the thigh movement assembly (16) is attached to the calf movement assembly (18) through a second bearing connected to the one or more support structures or plates (20). In another aspect, the one or more holes in the support structures or plates and the hip movement assembly are fitted with the first bearing and the second bearing to allow rotation between the hip movement assembly and the thigh movement assembly. In another aspect, the central nervous system impairment comprises a hemiplegic stroke, a paraparesis from spinal cord injuries, an upper motor neuron syndrome, a serious mobility-related disability or any combinations thereof. In another aspect, the knowledge-based control system controls at least one of the height adjuster assembly (12); the hip movement assembly (14); the thigh movement assembly (16); and the calf movement assembly (18). In another aspect, the knowledge-based control system further comprises:

one or more measurement systems for measuring stride-to-stride changes in gait of a human subject; and a quantitative system for movement analysis based on stride-to-stride changes in gait of the human subject. In another aspect, the one or more measurement systems are selected from a group comprising accelerometers, gyroscopes, goniometers, electromyography (EMG) units, and instrumented treadmills. In another aspect, the knowledge-based control system further comprises: a database module (40), a decision/inference module (42), a knowledge base module (36), one or more modules (38) for identification of a problem and for receiving data from one or more sensors wherein the knowledge-based control system is connected to a lower limb movement structure control system (50); and to a biological information feedback monitor module (46) that provides feedback to a patient. In another aspect, the method further comprises the step of identifying a human subject suspected of having a central nervous system impairment is selected from at least one of a hemiplegic stroke, a paraparesis from spinal cord injuries, an upper motor neuron syndrome, a serious mobility-related disability or any combinations thereof.

### BRIEF DESCRIPTION OF THE DRAWINGS

For a more complete understanding of the features and advantages of the present invention, reference is now made to the detailed description of the invention along with the accompanying figures and in which:

FIG. 1 is a model illustrating the design of the Smart Gait Rehabilitation System (SGRS);

FIG. 2 is a block diagram showing the imbedded knowledge-based system of the SGRS device of the present invention;

FIG. 3 is a block diagram showing the knowledge-based control system associated with the SGRS device of the present invention; and

FIG. 4 is a block diagram showing the knowledge-based system of the SGRS device of the present invention.

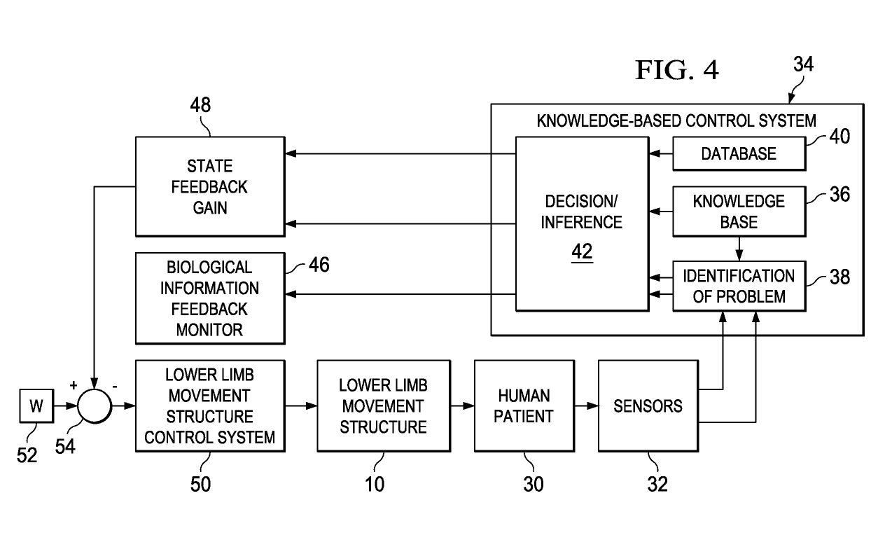

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

One purpose of this invention is to develop an automated diagnostic and therapeutic technique to improve recovery processes after neurologic impairment and to strongly emphasize functional training as the key to optimal functional recovery of gait after impairment.

Hemiplegic stroke, paraparesis from spinal cord injuries, and other upper motor neuron syndromes frequently cause serious mobility-related disabilities. The rehabilitation process is labor intensive. For many disorders, the most effective types of therapeutic intervention vary and difficult to determine. Patient evaluation is often subjective, foiling determination of precise rehabilitation goals and assessment of treatment effects. An imbedded knowledge-based system will perform quantitative analysis of human movements based on the simultaneous measurement of within-subject stride-to-stride changes in gait using accelerometers, gyroscopes, goniometers, and electromyography (EMG). It will provide adequate knowledge of the patient and disease characteristics that determine functional outcome. The system will strictly adhere to adequate designs, restrictive selection criteria and repeated measurements over time, based on clinimetric sound instruments. This way, the system can contribute to a better understanding of recovery in general and patient characteristics that allow for an early reliable prediction of the final outcome in particular. It will also enable individually tailored optimal treatment programs to be implemented.

The Smart Gait Rehabilitation System (SGRS) will offer capabilities unavailable using current gait therapy devices and methods. The SGRS, a multi-axis robotic device, will offer capabilities unavailable using current gait therapy devices and methods. Current commercial robotic assistive devices automatically drive the limbs passively through preset gait cycles. The devices do not take into account the kinematics and torques that a subject can generate, or incorporate the subject's growing ability to step. Passive step training would not seem to be an effective form of motor learning for retraining a complex motor skill such as walking Step-Training that incorporates sensory feedback, provides feedback about kinematics and torques, and proceeds at walking speeds typical of overground ambulation would be more likely to drive basic mechanisms of motor learning and representational plasticity for the lower extremities. Potential health benefits resulting from these capabilities include more effective and individualized therapy programs; the opportunity to lessen one of the most common disabilities in patients who suffer neurological diseases; reduce the time and labor needed to deliver therapy; and enhance gait-related diagnostic and research tools. To accomplish this, we will further develop a mechanical device based on the concept of task-oriented Partial Weight Bearing Treadmill Training (PWBTT) along with an innovative intelligent or knowledge-based control system that includes a knowledge-based sensing and a data acquisition scheme. The end result will be a therapy system that offers the patient, the doctor, and the therapist a new set of tools to test in clinical trials to improve gait therapy. The proposed device will also be well suited for use in gait diagnostic and research efforts. For example, perturbations during the step cycle can be incorporated into the control scheme to test postural adjustments and evaluate mechanisms of motor control. Development of the feedback system may also lend itself to devices for overground walking and for improving functional use of a paretic upper extremity.

The proposed development effort is structured to further develop a prototype, assess its safety in a trial phase, and set the ground work to assess its utility. The proposed development effort is structured to validate the elements of the invention including but not limited to:
1. The SGRS system will be able to offer both passive gait training and locomotor training with optimal feedback about kinematics and forces.
2. The SGRS system is safe for use in able-bodied adult subjects and in disabled adults who have a hemiparesis or paraparesis, across typical body sizes and leg lengths.
3. The data acquisition and presentation capabilities of the new device will provide a more thorough understanding of gait data directly related to a patient's locomotor therapy during treadmill training.
4. Data from able-bodied persons collected during SGRS testing will be similar to data gained from overground gait analysis.
5. Data related to improved gait parameters during SGRS training of disabled subjects will be reflected in parallel improvements in overground walking as training progresses.
6. The data gathering capabilities of the SGRS will improve the quality of data about pathological gait deviations during treadmill walking at normal casual walking speeds and provide objective data of outcome measures of change in individuals.

The smart gait rehabilitation system derives its intelligence from the fusion or transformation of multiple sensor data for the simultaneous measurements of the kinetic, kinematic and electromyographic data within the sensorimotor system. The efficiency and reliability of the multiple sensor system are ascertained through a sensor validation scheme, which will fulfill the tasks of detection and estimation. The former involves the discovery of a malfunction in a sensor while the latter may be subdivided into localization (establishing which sensor has failed); identification (determining the type of failure); and estimation (indicating the effect and extent of the failure).

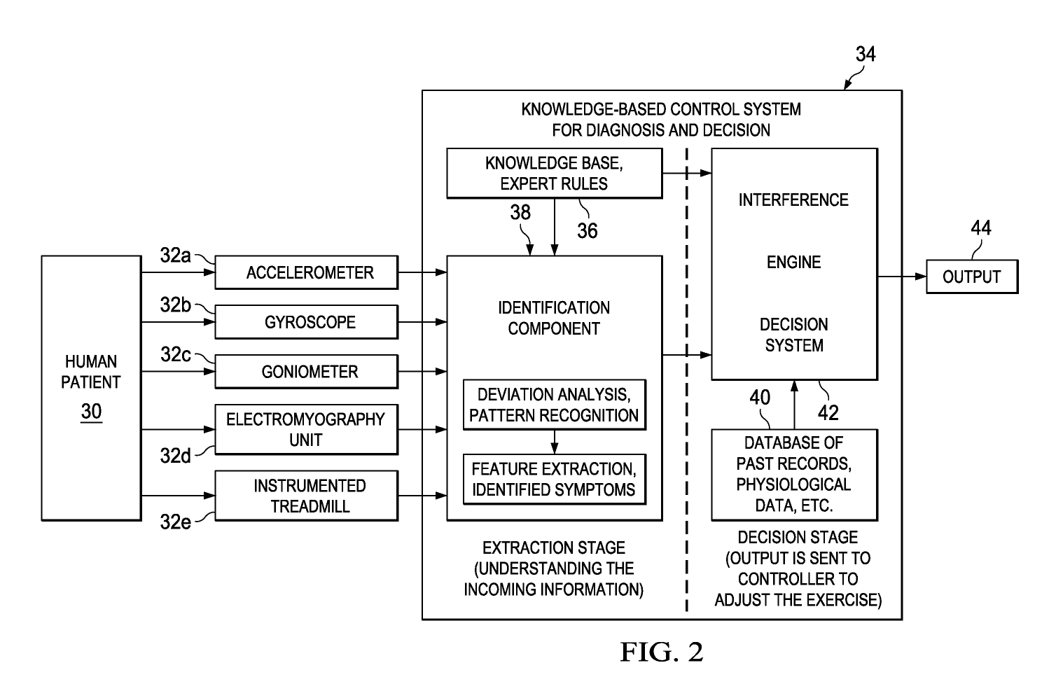

The sensor fusion scheme can be developed to integrate data from multiple sensors by using a fuzzy rule-based algorithm (see FIG. 2). The aim is to develop a multi-sensor system and fuse or transform the sensors' information together so that they gather the sensory inputs and output them to the smart gait rehabilitation system as if they were fabricated on a single chip. The sensor fusion or transformation can be used to solve the problem of integrating information from different sensory sources; organize the distributed sensing systems; integrate the sensors' diverse observations (inputs and outputs); coordinate and guide the decisions made by each sensor; and control devices with the goal of improving sensor system performance.

A further component of the invention enables both passive and active training of patients. In the one mode, the goal of the control is to make the device follow through a precise trajectory (gait) that is prescribed by the trainer. On the other hand, the control goal is to allow the patient lead whilst the device passively follows the patient's movement. While the former may be very suitable for a severely impaired patient or for someone at the very beginning of the rehabilitation process, the latter is for an advanced and trained patient, a recovered patient. Hence, a combination of the two modes makes the device still more intelligent and smart.

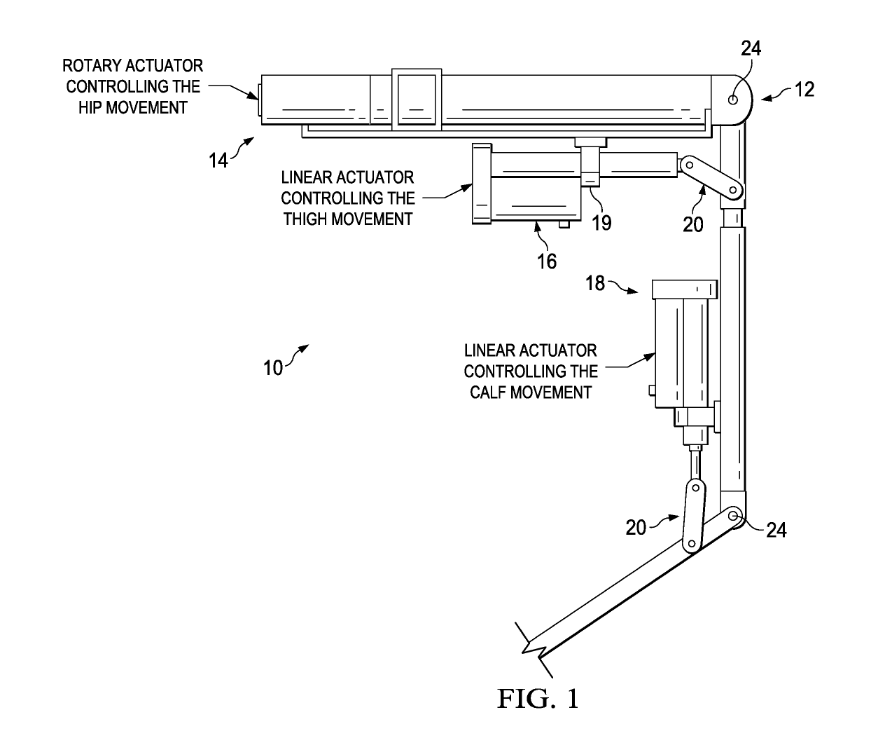

FIG. 1 shows the basic mechanical design and assembly of the present invention. The core mechanism is structured much like a human leg, and uses a moveable framework supported and driven by electromechanical actuators, as shown in FIG. 1. The mechanical design and assembly of the unitary device supports the emulation of kinematic gait. The device includes support structures and two powered lower limb movement structures. Lower limb movement structures can be secured to support using, e.g., bolts, attached to a linear actuator.

In FIG. 1, the lower limb movement structure 10 includes a height adjuster assembly 12, a hip movement assembly 14, a thigh movement assembly 16, and a calf movement assembly 18. The height adjuster assembly 12 is attached to the hip movement assembly 14 through a bearing mounted through holes in support plate elements 20. The hip movement assembly 14 is attached to the thigh movement assembly 16 through a bolt 19 protruding through the upper end of the linear actuator and through the hip movement assembly 14. Holes in support plates and hip movement assembly 14 (various parts) are fitted with bearings 24 allowing rotation between hip movement assembly 14 and thigh movement assembly 16. The thigh movement assembly 16 is attached to the calf movement assembly 18 through a bearing 24 inserted in holes in the support plates 20. The hip movement assembly 14 is a rotary actuator that controls the hip movement. The thigh movement assembly 16 is a linear actuator that controls the thigh movement. The calf movement assembly 18 is a linear actuator that controls knee movement.

FIG. 2 shows a knowledge-based control system 34 that will perform quantitative analysis of human movements based on the simultaneous measurements of within-subject stride-to-stride changes in gait using accelerometers, gyroscopes, goniometers, electromyography units and an instrumented treadmill. The measurements may be obtained from a plurality of sensors (designated with reference numerals 32a, 32b, 32c, 32d and 32e in FIG. 2) that receive human movement data from a human patient 30. Sensor 32a may comprise and accelerometer 32a. Sensor 32b may comprise a gyroscope 32b. Sensor 32c may comprise a goniometer 32c. Sensor 32d may comprise an electromyography unit 32d. Sensor 32e may comprise an instrumented treadmill 32e. In the embodiment of the knowledge-based control system 34 that is shown in FIG. 2 the output is designated with reference numeral 44.

The designed data acquisition scheme provides adequate knowledge of the patient and disease characteristics that determine functional outcome. The new system will strictly adhere to adequate designs, restrictive selection criteria and repeated measurements over time, based on clinimetric sound instruments.

The smart gait rehabilitation system offers step-training that incorporates sensory feedback, provides feedback about kinematics and torques, and proceeds at walking speeds typical of overground ambulation. This will present a more favorable methodology for driving basic mechanisms of motor learning and representational plasticity for the lower extremities.

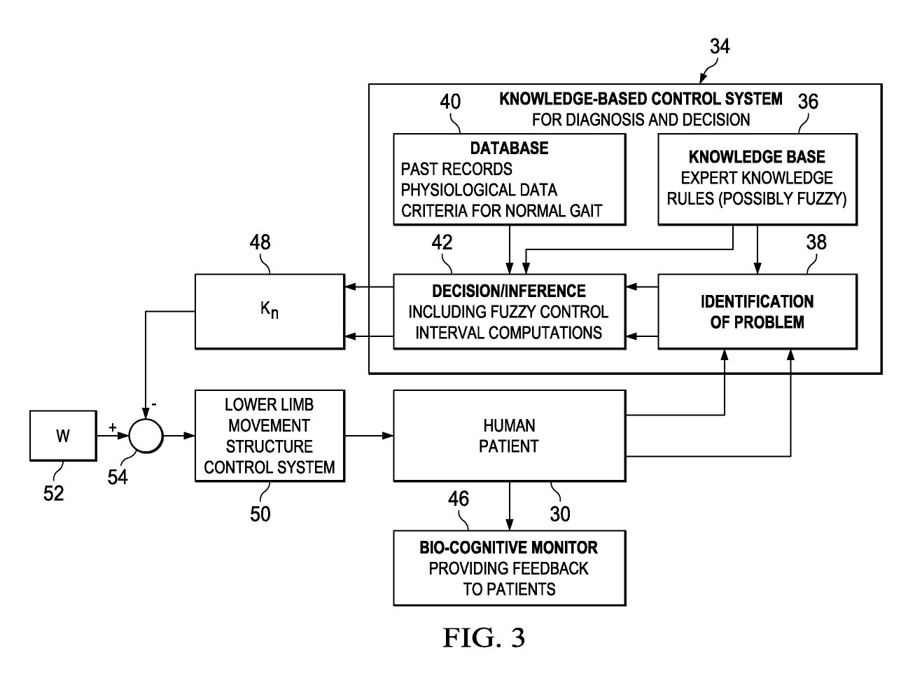

FIG. 3 shows another view of the Knowledge-based control system 34 (for diagnosis and decision), which includes a database module 40, a decision/inference module 42, a knowledge base module 36, a module 38 for the identification of problems and connections to the sensors 32a to 32e, which are connected to a human patient 30. The knowledge-based control system 34 is connected to a lower limb movement structure control system 50 and to a biological information monitor module 46 that provides feedback to the patient. A state feedback gain 48 (Kₙ) from the output of the knowledge-based control system 34 is combined with a reference signal 52 in an adder 54 and provided to the lower limb movement structure control system 50, which controls the elements of the lower limb movement structure 10. The sensing and data acquisition module and presentation system of the knowledge-based control system has the capabilities of providing more thorough understanding of gait directly related to a patient's locomotor therapy during treadmill training.

The SGRS device enforces the data gathering capabilities to improve the quality of data about pathological gait deviations during treadmill walking at normal casual walking speeds and provide objective data for outcome measures of change in individuals.

The SGRS also offers both passive gait training and locomotor training with optimal feedback about kinematics and forces and enables clinicians to predict, at an early post-impairment stage, the degree of disability the patient will ultimately experience. The knowledge-based system of the present invention enables individually tailored treatment programs to be implemented. The SGRS is a hybrid system, i.e., it incorporates both patient-in-the-loop and machine-in-the-loop strategies.

The SGRS system of the present invention overcomes some of the shortcomings of the current devices which include: (i) labor intensive for patients and therapists, (ii) Inability to produce accurate gait motion, (iii) no functionalities to measure gait parameters other than observation, (iv) passive training, (v) no consideration of kinematic parameters and (vi) high costs.

None of the current commercial rehabilitation robotic devices measure or support all the Gait motions: i.e. Pelvic Tilt, Pelvic Rotation, Vertical COM Motion, Horizontal COM Motion, Frontal and Transverse Thigh Rotation, and Knee Flexion Extension. The SGRS system of the present invention will offer capabilities unavailable using current gait therapy devices and methods.

Current commercial robotic assistive devices, such as the GAIT TRAINER GTI™ and the Locomat, automatically drive a subject's legs passively through the gait cycle. The devices do not take into account the torques that a subject can generate or incorporate the subject's growing ability to step. Passive step-training would not seem to be an effective form of motor learning for retraining a complex motor skill such as walking Step-training that incorporates sensory feedback, provides feedback about kinematics and torques, and proceeds at walking speeds typical of overground ambulation would be more likely to drive basic mechanisms of motor learning and representational plasticity for the lower extremities.

The SGRS device of the present invention provides a knowledge-based data acquisition and presentation system that has the capabilities of providing more thorough understanding of gait data directly related to a patient's locomotor therapy during threadmill training and enforces data gathering capabilities of the SGRS to improve the quality of data about pathological gait deviations during treadmill walking at normal casual walking speeds and provide objective data for outcome measures of change in individuals.

The SGRS system is based on step-training that incorporates sensory a feedback, providing feedback about kinematics and torques, and proceeds at walking speeds typical of overground ambulation. The system uses gait dynamics to determine the magnitude of the stride-to-stride fluctuations and their changes over time during walk to understand the physiology of gait in quantifying age-related and pathologic alterations in the locomotor control system, and in augmenting objective measurements of mobility and functional status. Finally the SGRS system offers both passive gait training and locomotor training with optimal feedback about kinematics and forces.

The SGRS system of the present invention has a lot of clinical relevance: (i) clinicians can predict, at an early post-impairment stage, the degree of disability the patient will ultimately experience, (ii) the knowledge-based system will provide adequate knowledge of the patient and disease characteristics that determine functional outcome, (iii) the knowledge-based system will limit the gap that remains between prognostic research and rehabilitation practice and (iv) the knowledge-base system will enable individually tailored treatment programs to be implemented.

The objective of neurological rehabilitation is to enable individual patients to achieve their full potential and to maximize the benefits from training, in order to attain the highest possible degrees of physical and psychological performance. The system described in the present invention embodies design and Knowledge-based components that provide patients the ability to regain their full potentials after impairment.

In addition to the advantages and features described above the present invention has the following features: (i) its design accommodates all motions, (ii) improved data acquisition and processing capabilities, (iii) it is a knowledge-based system, (iv) it is a hybrid control system (Patient-in-the-loop and Machine-in-the-loop), (v) the system strictly adheres to adequate designs, restrictive selection criteria and repeated measurements over time, based on clinimetric sound instruments, (vi) the system contributes to a better understanding of neurologic recovery in general and patient characteristics that allow for an early reliable prediction of the final outcome in particular, (vii) the system contributes to the creation of knowledge and technologies to illustrate that functional recovery after impairment is based on the concepts of neuroplasticity and reorganization of cerebral activity, (viii) the system can be individually tailored to implement optimal treatment programs to be implemented, (ix) unlike current devices does not automatically drive a subject's legs passively through the gait cycle, (x) unlike current devices takes into account the torques that a subject can generate or incorporate the subject's growing ability to step and (xi) helps clinicians to predict, at an early post-impairment stage and the degree of disability the patient will ultimately experience.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In certain other embodiments, the device(s), system(s) and method(s) may also be described in the claims with a more limited transition phrase, e.g., “consisting essentially of” or “consisting of”, which embodiments are also contemplated by the present invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 7,381,192: Therapeutic and/or training device for a person's lower limbs using a mechanical orthotic device and a neuromuscular stimulation device.

U.S. Pat. No. 7,179,234: Apparatus and method for characterizing contributions of forces associated with a body part of a subject.

United States Patent Application No. 20040172097: Therapeutic and/or training device for a person's lower limbs.

United States Patent Application No. 20050043661: Apparatus and method for characterizing contributions of forces associated with a body part of a subject.

United States Patent Application No. 20070135265: Apparatus and Method for Characterizing Contributions of Forces Associated with a Body Part of a Subject.

United States Patent Application No. 20050239613: Device and process for adjusting the height of and the relief force acting on a weight.

United States Patent Application No. 20050288157: Walking and balance exercise device.

What is claimed is:

1. A mechanical lower limb movement structure (10) for training one or more lower limbs of a subject having an impairment of the central nervous system, the mechanical lower limb movement structure comprising:
at least two powered lower limb structures;
one or more support structures or plates; wherein the at least two powered lower limb structures are secured to the one or more support structures or plates using bolts attached to a linear actuator; and
a knowledge-based control system that comprises a sensing and data acquisition module that simultaneously receives data from a plurality of sensors that are associated with the subject and that integrates data that is simultaneously received from the plurality of sensors using a fuzzy rule-based algorithm and that uses the integrated data to identify a gait motion of the subject.

2. The lower limb movement structure of claim 1, wherein the two or more powered lower limb structures comprise:
a height adjuster assembly (12);
a hip movement assembly (14); wherein the height adjuster assembly (12) is attached to the hip movement assembly (14) through a first bearing connected to the one or more support structures or plates (20);
a thigh movement assembly (16); wherein the hip movement assembly (14) is attached to the thigh movement assembly (16) by a bolt protruding through the upper end of the linear actuator wherein the bolt also protrudes through the hip movement assembly; and
a calf movement assembly (18); wherein the thigh movement assembly (16) is attached to the calf movement assembly (18) through a second bearing connected to the one or more support structures or plates (20).

3. The mechanical lower limb movement structure of claim 2, wherein one or more holes in the support structures or plates and the hip movement assembly are fitted with the first bearing and the second bearing to allow rotation between the hip movement assembly and the thigh movement assembly.

4. The device of claim 1, wherein a human subject suspected of having a central nervous system impairment is selected from at least one of a hemiplegic stroke, a paraparesis from spinal cord injuries, an upper motor neuron syndrome, a serious mobility-related disability or any combinations thereof.

5. The mechanical lower limb movement structure of claim 2, wherein the knowledge-based control system controls at least one of the height adjuster assembly (12); the hip movement assembly (14); the thigh movement assembly (16); and the calf movement assembly (18).

6. The mechanical lower limb movement structure of claim 5, wherein the knowledge-based control system further comprises:
one or more measurement systems for measuring stride-to-stride changes in gait of a human subject; and
a quantitative system for movement analysis based on stride-to-stride changes in gait of the human subject.

7. The mechanical lower limb movement structure of claim 6, wherein the one or more measurement systems are selected from a group comprising accelerometers, gyroscopes, goniometers, electromyography (EMG) units, and instrumented treadmills.

8. The mechanical lower limb movement structure of claim 5, wherein the knowledge-based control system further comprises:
a database module (40),
a decision/inference module (42),
a knowledge base module (36),
one or more modules (38) for identification of a problem and for receiving data from one or more sensors wherein the knowledge-based control system is connected to a lower limb movement structure control system (50); and
to a biological information feedback monitor module (46) that provides feedback to a patient.

9. A system for predicting the outcome of a physical therapy regimen or recovery in a patient following an impairment of the central nervous system, comprising:
a mechanical lower limb movement structure attachable to the patient; wherein the lower limb movement structure comprises two or more powered lower limb structures connected via one or more support structures or plates, and a knowledge-based control system that comprises a sensing and data acquisition module connected to one or more sensors that are associated with the patient and that integrates data that is simultaneously received from the plurality of sensors using a fuzzy rule-based algorithm;
one or more sensors that measure within-subject stride-to-stride changes of the patient;
analyzers that analyze movements quantitatively based on the measurements of the within-subject stride-to-stride changes; and
a unit that predicts the outcome of a physical therapy regimen or recovery in the patient based on the quantitative results of the measurements of the within-subject stride-to-stride changes.

10. The system of claim 9, wherein a human subject suspected of having a central nervous system impairment is selected from at least one of a hemiplegic stroke, a paraparesis from spinal cord injuries, an upper motor neuron syndrome, a serious mobility-related disability or any combinations thereof.

11. The system of claim 9, wherein the one or more sensors that measure within-subject stride-to-stride changes of the patient is selected from a group comprising accelerometers, gyroscopes, goniometers, and electromyography (EMG) units, and instrumented treadmills.

12. A mechanical lower limb movement structure for training one or more lower limbs of a subject having an impairment of the central nervous system, the mechanical lower limb movement structure comprising:
at least two powered lower limb structures; and
one or more support structures or plates; wherein the at least two powered lower limb structures are secured to the one or more support structures or plates using bolts attached to a linear actuator;
wherein the two or more powered lower limb structures comprise:
a height adjuster assembly (12);
a hip movement assembly (14); wherein the height adjuster assembly (12) is attached to the hip movement assembly (14) through a first bearing connected to the one or more support structures or plates (20);
a thigh movement assembly (16); wherein the hip movement assembly (14) is attached to the thigh movement assembly (16) by a bolt protruding through the upper end of the linear actuator wherein the bolt also protrudes through the hip movement assembly;
a calf movement assembly (18); wherein the thigh movement assembly (16) is attached to the calf movement assembly (18) through a second bearing connected to the one or more support structures or plates (20); and
a knowledge-based control system that comprises a sensing and data acquisition module that simultaneously receives data from a plurality of sensors that are associated with the subject and that integrates data that is simultaneously received from the plurality of sensors using a fuzzy rule-based algorithm and that uses the integrated data to identify a gait motion of the subject.

13. The system of claim 12, wherein one or more holes in the support structures or plates and the hip movement assembly are fitted with the first bearing and the second bearing to allow rotation between the hip movement assembly and the thigh movement assembly.

14. A method for making a passive gait or locomotor training regimen, or diagnosing gait for a subject, the method comprising the steps of:
attaching a lower limb movement structure (10) to the subject; wherein the multi-axis robotic device comprises two powered lower limb structures, one or more support structures or plates, a knowledge-based control system, a knowledge-based sensing and a data acquisition and control system;
measuring within-subject stride-to-stride changes using one or more measurement systems;
analyzing the movements quantitatively based on the measurements of the within-subject stride-to-stride changes; and
diagnosing gait or designing a gait or locomotor training regimen based on the quantitative results of the measurements of the within-subject stride-to-stride changes.

15. The method of claim 14, wherein the two or more powered lower limb structures comprise:
a height adjuster assembly (12);
a hip movement assembly (14); wherein the height adjuster assembly (12) is attached to the hip movement assembly (14) through a first bearing connected to the one or more support structures or plates (20);
a thigh movement assembly (16); wherein the hip movement assembly (14) is attached to the thigh movement assembly (16) by a bolt protruding through the upper end of the linear actuator wherein the bolt also protrudes through the hip movement assembly; and
a calf movement assembly (18); wherein the thigh movement assembly (16) is attached to the calf movement assembly (18) through a second bearing connected to the one or more support structures or plates (20).

16. The method of claim 15, wherein one or more holes in the support structures or plates and the hip movement assembly are fitted with the first bearing and the second bearing to allow rotation between the hip movement assembly and the thigh movement assembly.

17. The method of claim 14, wherein the central nervous system impairment comprises a hemiplegic stroke, a paraparesis from spinal cord injuries, an upper motor neuron syndrome, a serious mobility-related disability or any combinations thereof.

18. The method of claim 14, wherein the knowledge-based control system controls at least one of the height adjuster assembly (12); the hip movement assembly (14); the thigh movement assembly (16); and the calf movement assembly (18).

19. The method of claim 14, wherein the knowledge-based control system further comprises:
one or more measurement systems for measuring stride-to-stride changes in gait of a human subject; and
a quantitative system for movement analysis based on stride-to-stride changes in gait of the human subject.

20. The method of claim 14, wherein the one or more measurement systems are selected from a group comprising accelerometers, gyroscopes, goniometers, electromyography (EMG) units, and instrumented treadmills.

21. The method of claim 14, wherein the knowledge-based control system further comprises:
a database module (40),
a decision/inference module (42),
a knowledge base module (36),
one or more modules (38) for identification of a problem and for receiving data from one or more sensors wherein the knowledge-based control system is connected to a lower limb movement structure control system (50); and
to a biological information feedback monitor module (46) that provides feedback to a patient.

22. The method of claim 14, further comprising the step of identifying a human subject suspected of having a central nervous system impairment is selected from at least one of a hemiplegic stroke, a paraparesis from spinal cord injuries, an upper motor neuron syndrome, a serious mobility-related disability or any combinations thereof.
